(19) United States
(12) Patent Application Publication
(10) Pub. No.: US 2026/0186782 A1
(43) Pub. Date: Jul. 2, 2026

(54) MONITORING MEMORY TAG LOAD PERFORMANCE

(71) Applicant: Intel Corporation, Santa Clara, CA (US)

(72) Inventors: Anton Hanna, Nof HaGalil (IL); Joseph Nuzman, Haifa (IL); Michael LeMay, Hillsboro, OR (US); Joseph Cihula, Hillsboro, OR (US); Ahmad Yasin, Kafr Manda (IL)

(73) Assignee: Intel Corporation, Santa Clara, CA (US)

(21) Appl. No.: 19/003,528

(22) Filed: Dec. 27, 2024

(51) Int. Cl. G06F 9/30; G06F 11/34

(52) U.S. Cl. CPC G06F 9/30145; G06F 9/30043; G06F 11/3476

(57) ABSTRACT

Techniques for monitoring memory tag load performance are described. In an embodiment, an apparatus includes instruction decoder circuitry to decode a first instruction, the first instruction including an instruction format, the instruction format having a field for a value to indicate that execution of the first instruction is to include one or more memory tag checking operations; execution circuitry coupled to the instruction decoder circuitry, the execution circuitry to perform the one or more memory tag checking operations in response to the first instruction, wherein the one or more memory tag checking operations include a memory tag load operation; and performance monitoring circuitry to count occurrences of an event associated with the memory tag load operation.

### BACKGROUND

Computers and other information processing systems may store confidential, private, and secret information in their memories. Software may have vulnerabilities that may be exploitable to steal such information. Data corruption is also a risk. Hardware may also have vulnerabilities that may be exploited and/or adversaries may physically modify a system to steal information. Therefore, memory safety and security are important concerns in computer system architecture and design.

### BRIEF DESCRIPTION OF DRAWINGS

Various examples in accordance with the present disclosure will be described with reference to the drawings, in which:

FIG. 1 illustrates a processor for monitoring memory tag load performance according to embodiments.

FIG. 2A illustrates an example of a pointer format according to embodiments.

FIG. 2B illustrates a block diagram according to embodiments, including an enhanced compiler to instrument source code with instructions to check memory accesses.

FIG. 2C illustrates an example of looking up a tag in a tag table according to embodiments.

FIG. 2D illustrates an example tag table layout according to embodiments.

FIG. 3 illustrates a method for monitoring memory tag load performance according to embodiments.

FIG. 4 illustrates an example computing system according to an embodiment.

FIG. 5 illustrates a block diagram of an example processor and/or System on a Chip (SoC) that may have one or more cores and an integrated memory controller according to an embodiment.

FIG. 6A is a block diagram illustrating both an example in-order pipeline and an example register renaming, out-of-order issue/execution pipeline according to an embodiment.

FIG. 6B is a block diagram illustrating both an example in-order architecture core and an example register renaming, out-of-order issue/execution architecture core to be included in a processor according to an embodiment.

FIG. 7 illustrates examples of execution unit(s) circuitry according to an embodiment.

FIG. 8 illustrates the use of a software instruction converter to convert binary instructions in a source instruction set architecture to binary instructions in a target instruction set architecture according to an embodiment.

### DETAILED DESCRIPTION

The present disclosure relates to methods, apparatus, systems, and non-transitory computer-readable storage media for monitoring memory tag load performance. According to some examples, an apparatus includes instruction decoder circuitry to decode a first instruction, the first instruction including an instruction format, the instruction format having a field for a value to indicate that execution of the first instruction is to include one or more memory tag checking operations; execution circuitry coupled to the instruction decoder circuitry, the execution circuitry to perform the one or more memory tag checking operations in response to the first instruction, wherein the one or more memory tag checking operations include a memory tag load operation; and performance monitoring circuitry to count occurrences of an event associated with the memory tag load operation.

As mentioned in the background section, memory safety and security are important concerns in computer system architecture and design. Some approaches to providing memory safety (e.g., ARM Memory Tagging Extension (MTE)), which may be referred to as memory tagging, memory tag checking, tag checking, memory tagging technology, etc., involve associating (e.g., to indicate ownership) a first tag (or other metadata) with a memory location (e.g., by storing the first tag in the memory location alongside data, by storing the first tag in a table or other data structure indexed by an address of the memory location); comparing, to the first tag, a second tag (or other metadata) in an address pointer to the memory location in connection with an attempted access to the memory location; and allowing access to the memory location only if the second tag matches the first tag.

Some implementations of memory tagging introduce new load operations (e.g., to one or more stages of an execution pipeline) for loading the memory tag from a tag or metadata table in memory. In some implementations, execution of a data access and its dependent operations are not dependent on the result of a tag check, so the effect of tag loads on performance differ from the effect of normal demand data loads.

Therefore, the use of embodiments may be desirable to provide tailored handling of tag loads for performance monitoring purposes. Embodiments may provide for detecting micro-architectural performance bottlenecks in memory tagging environments, which could possibly be addressed with software optimizations. Embodiments may include one or more microarchitecture-abstracted performance monitoring events or counters that work on multiple implementations as well as a method to handle tag loads with existing counters and/or events. Embodiments may provide higher accuracy in bottleneck classification and/or improve the accuracy of methods that use performance monitoring events to build performance metrics (e.g., Intel® Top-down Micro-architectural Analysis (TMA)) when used to analyze performance data in a memory tagging enabled environment. Embodiments may provide specific performance monitoring capabilities to monitor tag loads when they negatively impact performance, which, combined with other performance monitoring capabilities (e.g., Intel® Timed Processor Event Based Sampling (PEBS)), may enable accurately pointing out which specific tag load is more likely to be hurting performance the most.

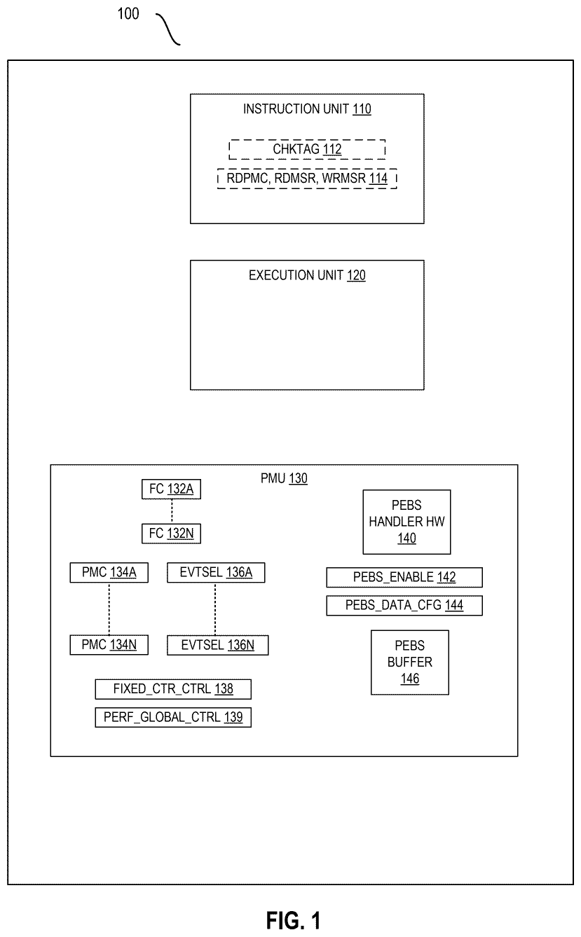

For example, FIG. 1 illustrates a processor 100 for monitoring memory tag load performance according to embodiments. Processor 100 may represent a hardware processor, processor core, execution core, core, etc., any of which may be referred to as a processor, core, etc., and/or all or part of a hardware component including one or more processors, cores, etc. integrated on a single substrate or packaged within a single package, each of which may include multiple execution threads and/or multiple execution cores, in any combination. Each processor represented as or in processor 100 may be any type of processor, including a general-purpose microprocessor, such as a processor in the Intel® Core® Processor Family or other processor family from Intel® Corporation or another company, a special purpose processor or microcontroller, or any other device or component in an information processing system in which an embodiment may be implemented. Processor 100 may be architected and designed to operate according to any instruction set architecture (ISA), with or without being controlled by microcode. For convenience and/or examples, some features (e.g., instructions, performance counters, registers, exceptions, etc.) may be referred to by a name associated with a specific processor architecture (e.g., x 86, Intel® 64, IA 32, linear address masking (LAM)), but embodiments are not limited to those features, names, architectures, etc.

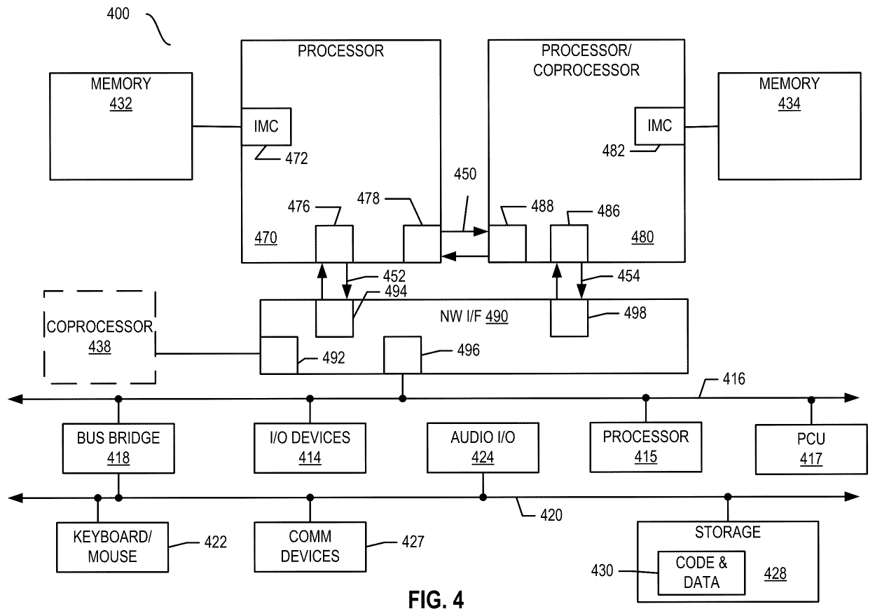

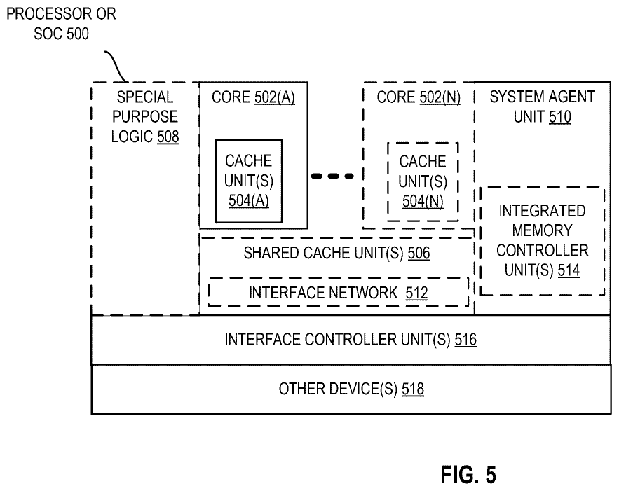

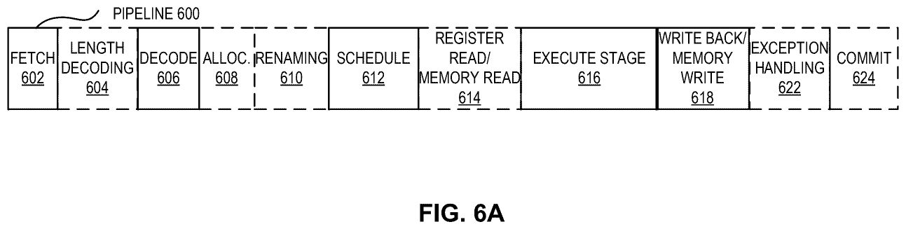

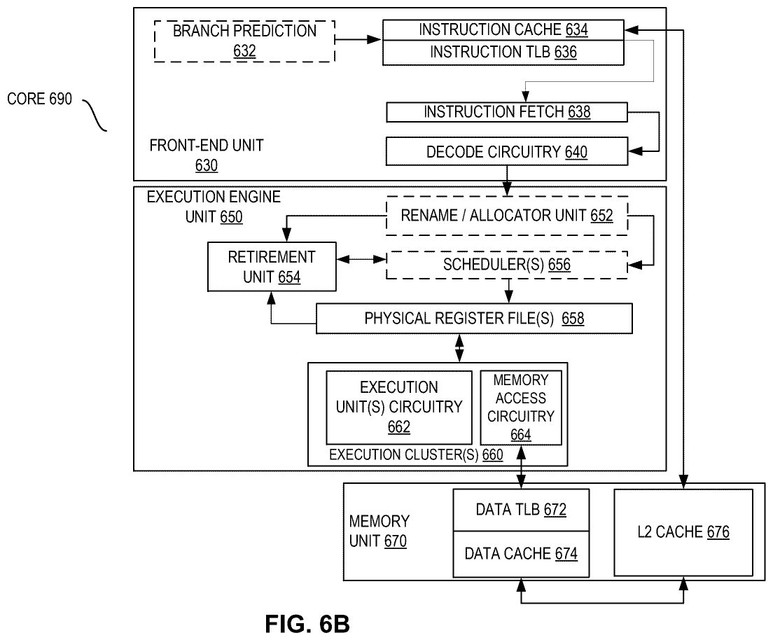

Processor 100 may be implemented in logic gates and/or any other type of circuitry, all, or parts of which may be included in a discrete component and/or integrated into the circuitry of a processing device or any other apparatus in a computer or other information processing system. For example, processor 100 in FIG. 1 may correspond to and/or be implemented/included in any of processors 470, 480, or 415 in FIG. 4, processor 500 or one of cores 502A to 502N in FIG. 5, and/or core 690 in FIG. 6B, each as described below.

As shown, processor 100 includes instruction unit 110, execution unit 120, and performance monitoring unit 130. Processor 100 may include any number of each of these elements (e.g., multiple execution units) and/or any other elements not shown in FIG. 1.

Instruction unit 110 may correspond to and/or be implemented/included in front-end unit 630 in FIG. 6B, as described below, and/or may include any combination of circuitry, logic gates, programmable logic array(s), look-up table(s), structures, hardware, etc., such as an instruction decoder, to fetch, receive, decode, interpret, schedule, and/or handle instructions, such as a memory tagging instruction 112 (e.g., CHKLDTAG, CHKSTTAG, another explicit ChkTag instruction, a ChkTag prefixed data access instruction, etc., as described below) and one or more read or write instructions 114 (e.g., RDMSR, WRMSR, RDPMC as described below) to be executed by processor 100. In FIG. 1, instructions that may be decoded or otherwise handled by instruction unit 110 are represented as blocks with broken line borders because these instructions are not themselves hardware, but rather that instruction unit 110 may include hardware or logic capable of decoding or otherwise handling these instructions.

Any instruction format may be used in embodiments; for example, an instruction may include an opcode and one or more operands, where the opcode may be decoded into one or more micro-instructions or micro-operations for execution by execution unit 120. Operands or other parameters may be associated with an instruction implicitly, directly, indirectly, or according to any other approach.

Embodiments may include a memory tag checking mechanism or architecture that may be referred to as ChkTag (pronounced ‘Check Tag’), but the use of the term ChkTag in this description is for example only and does not limit embodiments to mechanisms, architectures, etc. referred to as ChkTag. Embodiments, including ChkTag, may provide a mechanism to detect memory safety programming errors, such as buffer overflows and use-after-free, utilizing instructions, prefixes, and/or prefix bits inserted by compilers preceding memory accesses (e.g., potentially unsafe memory accesses).

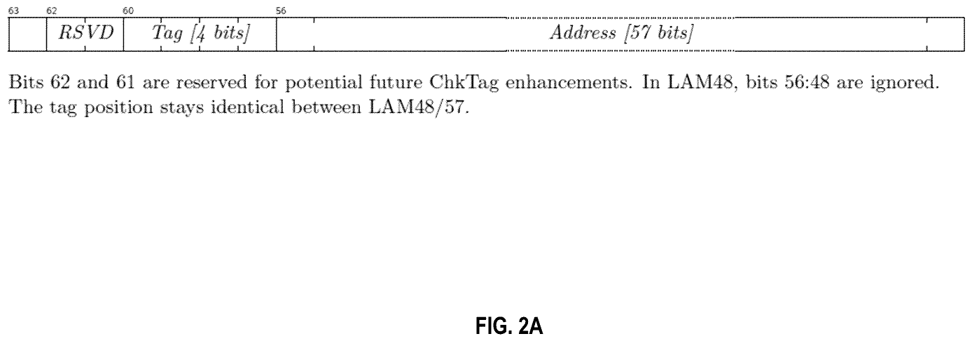

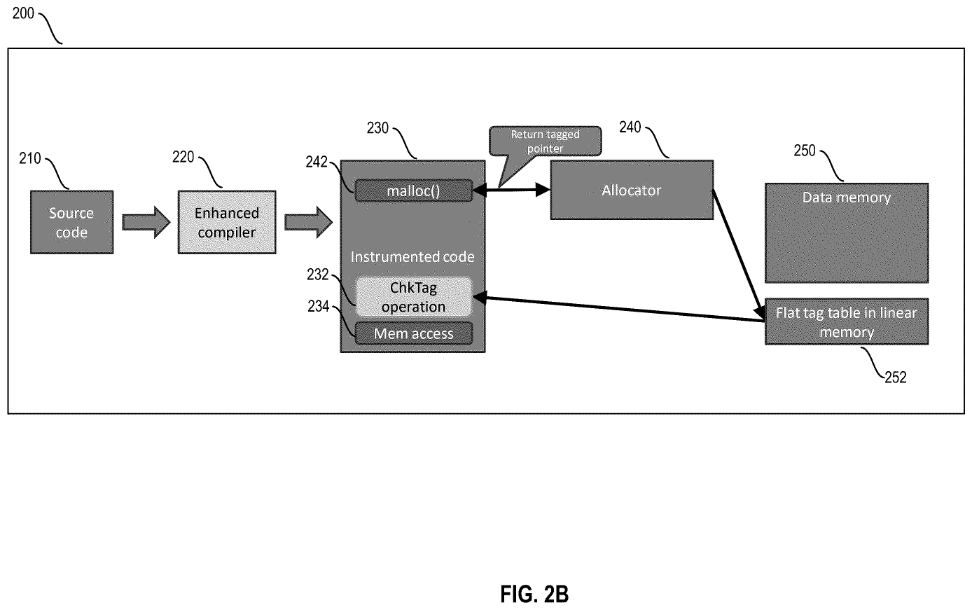

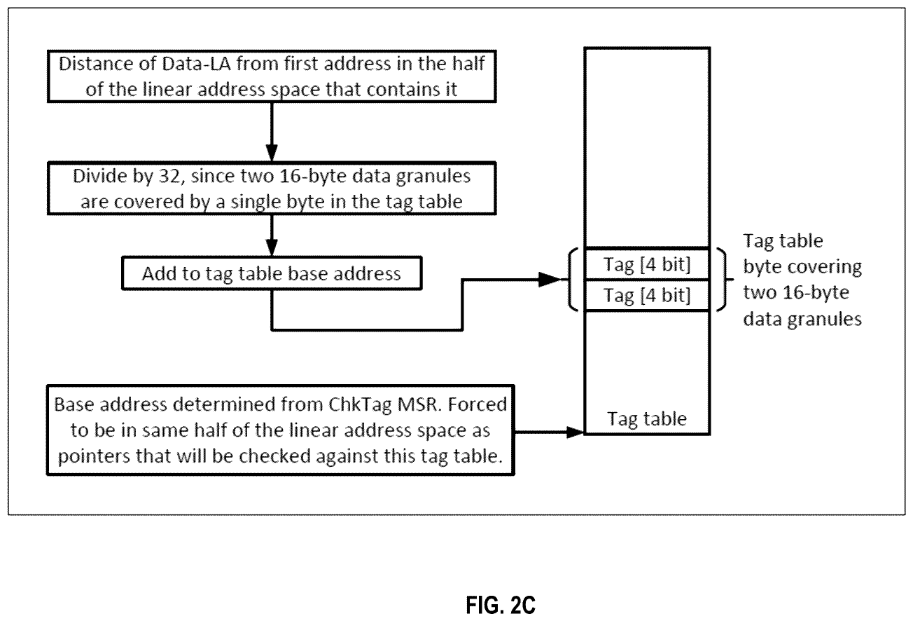

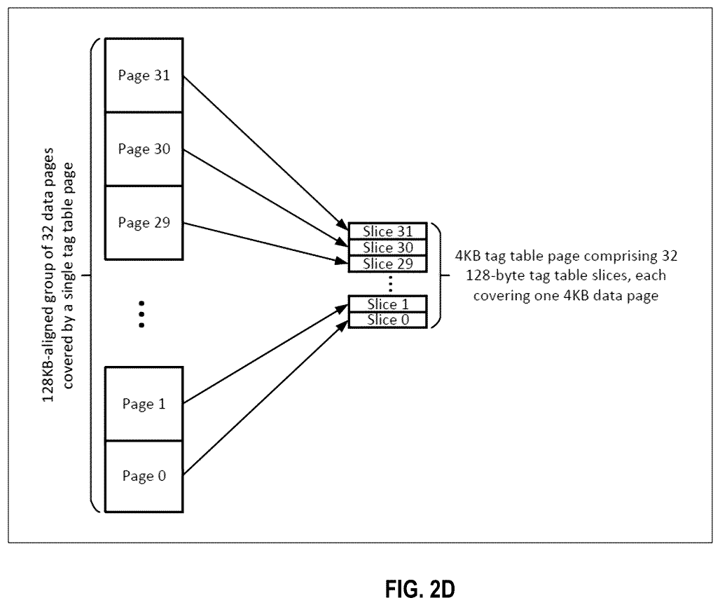

Embodiments may include associating tags with granules of memory and checking that the corresponding tag value is present in the pointer used to access the memory. An example of a pointer format is illustrated in FIG. 2A. If the tag in a pointer and the tag associated with the memory location do not match, an exception is generated.

In embodiments, instructions (e.g., explicit ChkTag instructions and/or ChkTag prefixed instructions as described below, any of which may be referred to as ChkTag instructions) may be inserted by compilers before potentially unsafe memory accesses to detect memory safety programming errors, such as buffer overflows and use-after-free. Instrumentation may be embedded within a binary program using a combination of instructions, prefixes, and/or prefix bits to selectively control tag checking. This opt-in model allows optimizing compilers and memory-safe language compilers to elide unneeded and undesired checks (e.g., accesses statically known to point to untagged regions (stack variables and global variables, accesses statically proved safe by the compiler, redundant checks, etc.). Optimizing compilers may also coalesce checking for multiple memory accesses into a smaller number of tag check instruction(s). Other benefits may include allowing the use of a streamlined instruction set to reduce implementation complexity and avoiding specialized additions outside the core, which avoids wasted silicon area for non-tagged usages.

FIG. 2B illustrates a block diagram 200 according to an embodiment, including an enhanced compiler 220 to instrument source code 210 with instructions to check memory accesses (e.g., ChkTag instructions), as well as memory allocator 240 to allocate (e.g., in response to malloc instruction 242) one or more portions of a memory (e.g., data memory 250) to a program, application, or other software. A memory allocator (e.g., allocator 240) may be implemented within system software (however, embodiments are not limited to software implementations of a memory allocator). In the resulting instrumented code 230, each memory access (e.g., memory access 234) is preceded by a ChkTag operation (e.g., ChkTag operation 232, which may be performed in response to a ChkTag instruction inserted before a memory access instruction or in response to a ChkTag prefixed instruction), in which a tag in a pointer associated with the memory access operation is compared to a stored tag (e.g., in flat tag table 252 in linear memory) associated with the corresponding memory location.

In embodiments, a ChkTag instruction may specify an access range within which tags in pointers are to be compared to tags associated with the corresponding memory locations. The access range may be specified by encoding both a memory operand for the base address and a data access size into the instruction. In other embodiments, the access range may be specified by a memory operand in the ChkTag instruction (e.g., the base register specifies the first byte of the access range and the effective address specifies the last byte of the access range). Some embodiments may incorporate segmentation support for computing the access range.

The following terms may be used in descriptions of embodiments. Definitions are given as examples, without limiting embodiments to these definitions (e.g., pointers may be other sizes instead of 64 bits, LA_MSB or other bit positions may differ, etc.). Likewise, any other references, in this description or corresponding figures, to bit positions or bit lengths in values, registers, tags, etc. are given as examples and do not limit embodiments to that which is referenced.
ChkTag prefix: A prefix or bit setting that can be applied to a subset of

instruction types that access memory to indicate that a ChkTag tag check may be needed, subject to ChkTag enabling.
Data-LA: Linear address of a memory access as used for paging. The resulting

address excludes the pointer tag bits.
LA_MSB: Index of most-significant linear address bit, from paging mode, not

LAM mode: 56 for LA 57, 47 for LA 48.
Pointer: 64-bit value generated by address computation, containing the tag and

the address.
Tag check: Comparison of pointer tag with corresponding tag(s) loaded from memory. Triggered by an CHKLDTAG or CHKSTTAG instruction or a ChkTag prefix, if enabled. Associated linear-address pre-processing checks, address space wrapping check, and reserved bit checks are also performed.
Tag-LA: Linear address used by the CPU to access an entry in the tag table during the tag check.

Examples of features that may be in included in a system architecture (e.g., ChkTag) according to embodiments:
CHKLDTAG and CHKSTTAG instructions that accept arbitrary memory
operands and specify the sizes of data accesses. Compilers and assemblers can use these to check arbitrary data accesses. These instructions may have an opcode corresponding to a no-operation (NOP) opcode in a first (e.g., existing, un-extended, non-extended) instruction set, such that they may be included in second (e.g., a backward-compatible instruction set and/or backward-compatible extension to the existing instruction set, either of which may be referred to as an extended instruction set).
CHKLDTAG instructions generate tag-checking operations meant for

checking associated load operations. They have an explicit size, but do not return data in any register. Tag checking occurs when load checks are enabled for the supplied memory operand. ChkTag supports dynamically selecting store-only checking, which causes load-based checks to be skipped. A tag mismatch will result in an exception.
CHKSTTAG instructions generate tag-checking operations meant for

checking associated store operations. They have an explicit size, but do not return data in any register. Tag checking occurs when store checks are enabled for the supplied memory operand. A tag mismatch will result in an exception.
Prefix bit or byte for certain MOV-type instructions to generate ChkTag operations with reduced code size overhead compared to CHKLDTAG and CHKSTTAG instructions.
Separate tag table in linear memory for each half of the linear address space.

Software configures tag table locations using new model-specific registers (MSRs). The size of the linear address reservation for each tag table is 1/32^{nd} the size of each half of the linear address space covered by the table. The linear address space size is determined by the paging mode. Pages in the tag table linear range can initially be uncommitted. The set of committed tag table pages can be enlarged on demand as tags are initialized for additional data pages to provide a pay-as-you-go model. An alternative is to narrow the checked ranges of the linear address space, which would result in a corresponding reduction in the tag table linear reservation. It would also be possible to define more than two checked address ranges. A distinct tag table base address may be specified for each checked range.
Tagging is at 16-byte granularity with a 4-bit tag size. Other granularities and

tag sizes are possible.
Tags can be read/written with all existing types of load/store instructions. This

permits optimized tag table accesses. For example, allocators can limit use of locked tag update operations to just the places where they are actually necessary. Allocators can also use single instruction multiple data (SIMD) instructions for performing bulk tag updates. Large memory operations, e.g., in string and memory library routines, can perform SIMD loads and checks directly on tag memory using existing instruction types.
Precise mismatch detection, even for stores.
Controls in new MSRs to allow software to dynamically select checking modes (e.g., off (e.g., for minimal overhead), load and store (e.g., for maximum security coverage), and store-only (e.g., for intermediate overhead) separately for each half of the linear address space. Overheads may scale with the extent of tagging. For example, processes with a variety of configurations may exist atop a shared kernel (which may itself be tagged or untagged and instrumented or uninstrumented, with dynamically configurable modes for load and store, store-only, or disabled checks if tagged): 1) tagged process with load and store checks, 2) tagged process with store-only checks, 3) instrumented process with tagging disabled (e.g., minimal overhead, just from additional instructions treated as NOPs and ignored prefixes), and 4) uninstrumented process (zero overhead from ChkTag).
Other types of metadata in addition to tags could potentially be encoded into pointers and/or stored in metadata tables, such as single-or double-ended bounds, version, permission bits, a compartment identifier (ID), privilege level, accessed and/or dirty bits, identifier for code authorized to access the data such as a hash value, key, KeyID, tweak value or integrity value (IV) or counter value used by the processor circuitry to encrypt/decrypt data and/or other metadata, an aggregate cryptographic message authentication code (MAC) value, Integrity-Check Value (ICV), or ECC code for the data allocation, element size, e.g., to allow generating an error if an attempt is made to access an allocation at an offset that is not an even multiple of the element size, and data object size, e.g., to permit generating an exception when accessing invalid locations outside of the data object, even if the space reserved for the allocation is larger than the size needed for the data object.

FIG. 2C illustrates an example of looking up a tag in a tag table. In embodiments, each tag covers a 16-byte naturally aligned granule of memory. The tag for a given access attempt may be located by first dividing by 32 the distance of the linear address for the data from the first address in the half of the linear address space that contains it. If the implementation supports narrowing the checked range(s), then the distance is instead computed from the beginning of the checked range containing the linear address for the data. The reason for dividing by 32 rather than the granule size of 16 bytes is that a single tag table byte contains two tags. Second, that scaled address is added to the base address for the tag table to generate the final linear address for the tag byte.

FIG. 2D illustrates an example tag table layout for an example based on 4KB linear data pages (e.g., tag table coverage of data pages). To check an access, the tag for each granule to be accessed is loaded from the tag table and compared to the tag in the pointer. If any of the loaded tags does not match the tag in the pointer, an exception is generated.

In embodiments, tag loads may adhere to the ordinary memory ordering model for a load, with no fencing needed. In embodiments, a ChkTag-prefixed instruction performs a tag load followed by a Data-LA (data linear address) access. The tag load may be repeated due to a fault occurring later in the instruction leading to software re-executing the instruction from its beginning. Furthermore, tag loads may be repeated even without a fault occurring. However, ChkTag prefixing may avoid introducing any new instances of repeated Data-LA accesses in embodiments where tag loads and checks are ordered ahead of Data-LA accesses. Software may avoid performing tag loads from uncacheable (UC) memory where side effects may occur due to memory mapped input/output (MMIO). Other embodiments may order tag loads and checks in other ways with respect to Data-LA accesses.

In connection with tag load address ranges, embodiments may include the following:
The number of tag bytes to be loaded for a tag check operation depends both on the size of the access being checked and on the alignment of the Data-LA.
Tag loads are aligned to avoid generating page faults and extended page table (EPT) violations for pages outside of those containing the actual tag bytes needed for the current check.

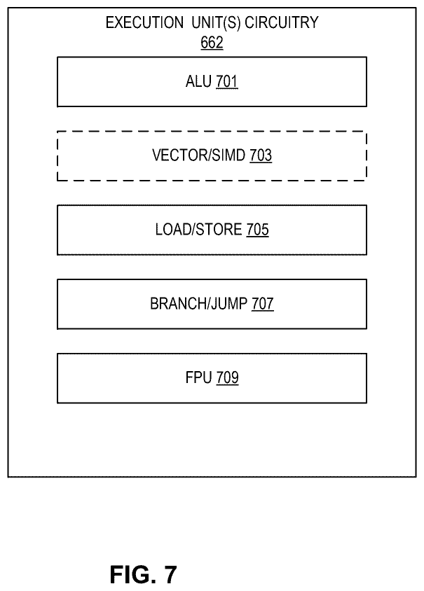

Returning to FIG. 1, execution unit 120 may correspond to and/or be implemented/included in any of execution engine 650 and/or execution cluster(s) 660 in FIG. 6B and/or execution unit circuitry 662 in FIGS. 6B and 7, each as described below, and/or include any circuitry, logic gates, structures, and/or other hardware, such as arithmetic units, logic units, floating point units, shifters, load-store units, etc., to execute instructions, process data, and/or perform operations in response to decoded instructions (e.g., micro-instructions, micro-operations (uops), control signals generated by instruction unit 110). Execution unit 120 may represent any one or more physically or logically distinct execution units.

Performance monitoring unit (PMU) 130 may include any circuitry, logic, structures, and/or other hardware to measure, monitor, and/or log performance information related to processor 100, software running on processor 100, and/or a system including processor 100. PMU 130 may include one or more performance monitoring (perfmon) counters 132A to 132N and 134A to 134N to count occurrences of clock cycles, events, events of a particular type, operations, occurrences, actions, conditions, processor parameters, or any other measure of or related to performance (any of which may be referred to for convenience as an event and/or counting an event). For example, a perfmon counter may increment or decrement for each occurrence of a selected event or increment or decrement for each clock cycle during a selected event. The events may include any of a variety of events related to execution of program code on processor 100, such as instructions retired, core clock cycles, reference clock cycles, cache references, cache misses, branch instructions retired, branch mispredictions retired, an event (examples of which are described below) related to tag loads, etc. Therefore, perfmon counters may be used in efforts to tune or profile program code to improve or optimize performance.

In embodiments, perfmon counters may generate a performance record and/or a performance monitoring interrupt (PMI) when the counter overflows, where for convenience, a counter overflow may refer to a counter reaching or exceeding its maximum value (e.g., when incrementing), reaching zero or otherwise underflowing (e.g., when decrementing from a positive starting count), reaching zero (e.g., when decrementing from a positive starting count or incrementing from a negative starting count), otherwise reaching or passing a fixed or programmable target value (e.g., when incrementing or decrementing), etc. For example, a counter may be preset to a modulus value that may cause the counter to overflow after a specific number of events have been counted, which may generate a PMI and/or a performance record, such as a precise event-based sampling (PEBS) record, as described below.

One or more perfmon counters (e.g., 132A to 132N) may be fixed function (e.g., dedicated to counting only a particular event, such as instructions retired, core clock cycles, reference clock cycles) counters, any of which may be referred to as a fixed perfmon counter, fixed counter, FC, FCx where x is a number, FIXED_CTR, FIXED_CTRx where x is a number, etc.). One or more perfmon counters (e.g., 134A to 134N) may be general-purpose (e.g., programmable to count a particular selectable event, such as cache references, cache misses, branch instructions retired, branch mispredictions retired, and reconfigurable to count a different selectable event) counters, any of which may be referred to as a general-purpose perfmon counter, general-purpose counter, programmable perfmon counter, programmable counter, PMC, PMCx where x is a number, etc.). In various embodiments, perfmon counters (or any set or subset of perfmon counters) may be within and/or accessible by a core (core-scoped) or external to a core (e.g., within an uncore or system agent) and/or accessible by more than one core (package-scoped).

In embodiments, any such general purpose perfmon counter (e.g., any or each of PMCs 134A to 134N) may be programmable or configurable to count one or more events related to tag loads, such as, but not limited to, instructions that include a tag load that have been committed to retirement, tag load uops dispatched to execution, uops decoded into NOPS from ChkTag instructions, each as described below. In embodiments, fixed function counters (e.g., 132A to 132N) may be used to count these events.

Processor 100 also includes a mechanism for perfmon counters to be used. For example, PMU 130 may include and/or be connected to one or more storage locations for accessing (e.g., reading, programming, enabling) counters. In embodiments, such storage locations may be model/machine specific registers (MSRs) and/or may be referred to for convenience as MSRs. Some such MSRs may be specific to a processor or processor architecture (e.g., Intel® 64 and/or IA 32) and/or some may be more specifically described below. In various embodiments, MSRs (or any set or subset of MSRs) may be within and/or accessible by a core (core-scoped) or external to a core (e.g., within an uncore or system agent) and/or accessible by more than one core (package-scoped).

In an embodiment including fixed-function perfmon counters (e.g., 132A to 132N), processor 100 may include one or more other MSRs that may be associated with (e.g., used to configure, control, provide status of) one or more FCs, and in an embodiment including general-purpose perfmon counters (e.g., 134A to 134N), processor 100 may include one or more other MSRs that may be associated with (e.g., used to configure, control, provide status of) one or more PMCs. For example, processor 100 may include a fixed perfmon counter control MSR 138 (which may be referred to as FIXED_CTR_CTRL) associated with multiple FCs (e.g., to selectively enable or disable multiple FCs with a single write to the MSR), a global perfmon counter control MSR (which may be referred to as PERF_GLOBAL_CTRL) 139 associated with multiple FCs and/or PMCs (e.g., to selectively enable or disable multiple FCs and/or PMCs with a single write to the MSR), and/or one or more event selection MSRs 136A to 136N (any of which may be referred to as an EVTSEL, PERFEVTSEL, EVTSELx where x is a number, or PERFEVTSELx where x is a number MSR), each of which correspond to one of PMCs 134A to 134N and may be programmed to select (e.g., with bits 7:0) an event to be counted by its corresponding PMC and to enable (e.g., with bit 22, which may be set to 1 to enable and cleared to 0 to disable) its corresponding PMC. Accordingly, processor 100 may include more than one way to enable/disable FCs and/or PMCs individually and/or in groups. Other perfmon MSRs are possible.

In embodiments, the instruction set of processor 100 may include instructions to access (e.g., read and/or write) perfmon counters and/or MSRs associated with perfmon counters, such as an instruction to read a perfmon counter (RDPMC), an instruction to read from an MSR (RDMSR), and an instruction to write to an MSR (WRMSR).

Embodiments may provide for performance monitoring to include a capability, mechanism, facility, feature, architecture, hardware, etc. for capturing any possible subset of counts from or information (e.g., performance metrics) related to a processor's perfmon counters into a record that may be read independently from the execution of software being monitored (e.g., without the execution of a RDPMC or RDMSR instruction). Embodiments may include a performance monitoring capability, mechanism, facility, feature, architecture, hardware, etc. that captures records including processor state, such as Intel® precise event-based sampling (PEBS), Intel® non-precise event-based sampling (NPEBS), AMD instruction based sampling (IBS), ARM statistical profiling extension (SPE). For convenience, embodiments may be described with reference to PEBS, but embodiments are not limited to PEBS or any other specific feature or architecture.

As used herein, a precise event is an event that is linked to a specific instruction or micro-operation in an instruction trace and occurs when that instruction or micro-operation retires, and/or a monitored event that may be used with a PEBS or other such sampling mechanism to produce precise samples of instructions that had the monitored event happen to them and can then be consumed by software.

Such precise events may include, but are not limited to, instructions retired, branch instructions retired, cache references, cache misses, instructions that include a tag load that have been committed to retirement, tag load uops dispatched to execution, and uops decoded into NOPS from ChkTag instructions (each of the latter three as described below). A non-precise event is an event that is either not linked to a specific instruction or micro-operation in an instruction trace or can occur speculatively even when the instruction or micro-operation does not retire. By way of example, a non-precise event may include, but is not limited to, reference clock cycles, core clock cycles, clock cycles when interrupts are masked, etc.

The operation of a processor may include the occurrences of events, as described above, including but not limited to events counted by or otherwise associated with software-readable perfmon counters. An event may be a response to a given instruction and/or data stream in the processing device. Events may be associated with architectural metadata including state information of the processor including, but not limited to, an instruction pointer, a time stamp counter, and register state.

In some embodiments, a processor is monitored to track precise and non-precise events. In some embodiments, the processing device tracks precise and/or non-precise events and stores architectural metadata regarding the events in a non-intrusive manner utilizing a mechanism on the processing device without the intervention of an interrupt (e.g., a PMI).

As shown, for example, in PMU 130 in FIG. 1, implementation of a PEBS feature or mechanism may include a PEBS handler circuit or hardware (e.g., PEBS handler HW 140) and one or more registers or other storage locations to enable and/or control the PEBS feature, such as a PEBS enable MSR (e.g., PEBS_ENABLE MSR 142) and a PEBS data configuration MSR (PEBS_DATA_CFG MSR 144).

In embodiments, PEBS data may be collected, captured, recorded, written, saved, etc. (e.g., in a PEBS buffer 146 and/or as a PEBS record) in response to or in connection with any one or more events, such as but not limited to the overflow of a performance monitoring counter. For example, PEBS_ENABLE MSR 142 may include one or more bits, each corresponding to a performance monitoring counter, that may be set to enable capture (e.g., by PEBS handler HW 140) of a PEBS record in response to the overflow of the corresponding performance monitoring counter. Enabling capture of a PEBS record may also be based on enabling one or more corresponding performance monitoring counters as described above (e.g., using a FIXED_CTR_CTRL, PERF_GLOBAL_CTRL, and/or EVTSEL MSR).

Embodiments may include new performance monitoring events that account for tag loads activity in a processor (e.g., processor 100, an instruction processing pipeline in a processor, and/or a logical processor running on a hardware processor). For example, new perfmon events may include:
A Precise Event (e.g., Called Mem_inst_retired.chktag_load) to count the number of instructions that include a tag load and have been committed to retirement (or retired). In embodiments, when used with existing capabilities of a precise event to count the number of instructions that include a memory access and have been committed to retirement (e.g., MEM_INST_RETIRED), it may be used to count cases where a specific performance critical event happened to the tag load (such as translation lookaside buffer (TLB) miss or page split). In embodiments, it may be used with an event based sampling mechanism (e.g., PEBS) to generate samples with information about tag loads. In embodiments, when used with a retirement delay monitoring feature (e.g., Timed PEBS), it may be used to locate problematic and slow tag loads, which may then be handled with a known software optimization technique such as software prefetching.
An event (e.g., called UOPS_DISPATCHED.CHKTAG_LOAD) to count the number of tag loads (e.g., tag load uops decoded) dispatched to execution (e.g., to an execution unit, to a reservation station for scheduling, to a back-end of an instruction processing pipeline). In embodiments, when used in metrics defined by bottleneck analysis methods (e.g., TMA) may be used to help evaluate the impact of tag loads on execution bandwidth in an out-of-order execution part of the processor. In embodiments, this event used with MEM_INST_RETIRED.CHKTAG_LOAD may give a hint of the number of tag loads that were executed on a wrong control speculative path which then had to be cleared and discarded.
an Event (e.g., Called Uops_decoded.chktag_nops) to Count the number of NOPs (e.g., uops corresponding to no operation) decoded from ChkTag instructions. In embodiments, this event may help evaluate the impact of a memory tagging feature, when disabled, on the frontend of the machine in the disabled mode. For example, code compiled with a memory tagging feature (e.g., ChkTag) might introduce NOP micro-operations at decode when the feature is disabled, which can add stress on code fetching bandwidth.

Embodiments may include methods to handle tag loads to distinguish them from regular data loads using existing performance monitoring events. For example, embodiments may include distinguishing and excluding tag loads from triggering or counting events that are defined to help evaluate performance impact of normal data loads. As mentioned before, in memory tagging implementations such as ChkTag, a tag load operation is a separate micro-operation than the data loads that it tries to tag check for, and in some cases (e.g., explicit ChkTag instructions), the data load does not depend on the tag check result to start execution and instead is executed speculatively, which means that the dependencies of that data load can also continue executing speculatively and are independent of the tag load and check. Therefore, tag loads may affect performance in a dramatically different way than a normal demand data load would, hence the desire for the separation.

Some implementations of handling certain types of events such as tagging violations or page table accessed and dirty bit updates may lead to tag loads being repeated, with the effects of the initial tag loads and comparisons being discarded, which may lead to tagging violations being missed in cases where the initially loaded tag value(s) mismatch with the pointer tag whereas the subsequently loaded tags match the pointer tag. In embodiments, a performance counter may be defined for such instances, which may allow software to detect tag checking race conditions.

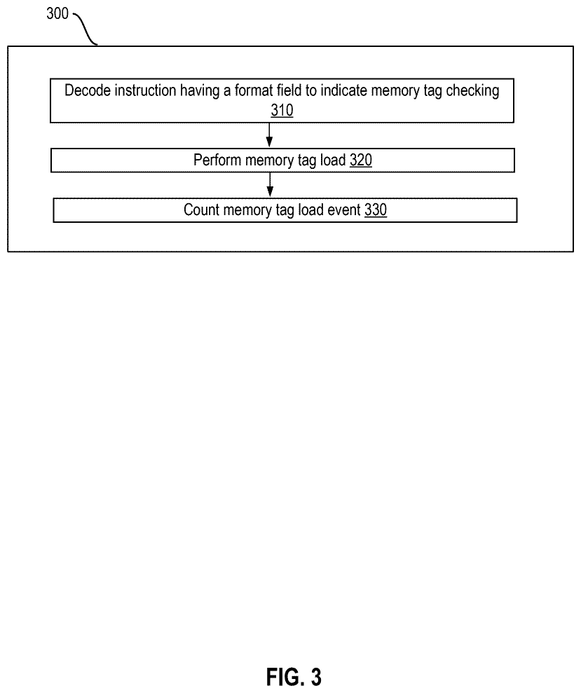

FIG. 3 illustrates a method 300 for monitoring memory tag load performance according to embodiments.

In 310, a first instruction is decoded (e.g., by instruction decoder circuitry in instruction unit 110). The first instruction includes an instruction format having a field for a value to indicate that execution of the first instruction is to include one or more memory tag checking operations. For example, the field may be an opcode field or a prefix field.

In 320, one or more memory tag checking operations are performed (e.g., by execution circuitry in execution unit 120) in response to the first instruction, wherein the one or more memory tag operations include a memory tag load operation.

In 330, occurrences of an event associated with the memory tag load operation are counted (e.g., by performance monitoring circuitry in performance monitoring unit 130). For example, the event for which occurrences are counted may be any event associated with a tag load, such as those described above (a commitment to retire or retirement of the first instruction, a dispatch of the memory tag load operation to be executed, a decode of the first instruction into a no-operation (NOP)). In embodiments, the event does not include a data load operation (e.g., a tag load is distinguished from a data load, as described above). The event is a tagging violation (e.g., as described above).

Example apparatuses, methods, etc.

According to some examples, an apparatus (e.g., a hardware processor, processor core, execution core, etc.) includes instruction decoder circuitry to decode a first instruction, the first instruction including an instruction format, the instruction format having a field for a value to indicate that execution of the first instruction is to include one or more memory tag checking operations; execution circuitry coupled to the instruction decoder circuitry, the execution circuitry to perform the one or more memory tag checking operations in response to the first instruction, wherein the one or more memory tag checking operations include a memory tag load operation; and performance monitoring circuitry to count occurrences of an event associated with the memory tag load operation.

Any such examples may include any or any combination of the following aspects. The event is a commitment to retire the first instruction or retirement of the first instruction. The event is a dispatch of the memory tag load operation to be executed. The event is a decode of the first instruction into a no-operation (NOP). The event does not include a data load operation. The event is a tagging violation. The field is an opcode field. The field is a prefix field.

According to some examples, a method includes decoding a first instruction, the first instruction including an instruction format, the instruction format having a field for a value to indicate that execution of the first instruction is to include one or more memory tag checking operations; performing the one or more memory tag checking operations in response to the first instruction, wherein the one or more memory tag checking operations include a memory tag load operation; and counting occurrences of an event associated with the memory tag load operation.

Any such examples may include any or any combination of the following aspects. The event is a commitment to retire the first instruction or retirement of the first instruction. The event is a dispatch of the memory tag load operation to be executed. The event is a decode of the first instruction into a no-operation (NOP). The event does not include a data load operation. The event is a tagging violation. The field is an opcode field. The field is a prefix field.

According to some examples, a non-transitory machine-readable medium having program code stored thereon which, when executed by a machine, causes the machine to perform the operations of decoding a first instruction, the first instruction including an instruction format, the instruction format having a field for a value to indicate that execution of the first instruction is to include one or more memory tag checking operations; performing the one or more memory tag checking operations in response to the first instruction, wherein the one or more memory tag checking operations include a memory tag load operation; and counting occurrences of an event associated with the memory tag load operation.

Any such examples may include any or any combination of the following aspects. The event is a commitment to retire the first instruction or retirement of the first instruction. The event is a dispatch of the memory tag load operation to be executed. The event is a decode of the first instruction into a no-operation (NOP). The event does not include a data load operation. The event is a tagging violation. The field is an opcode field. The field is a prefix field.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when decoded and/or executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors'local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 50 (A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2(L2 ), level 3(L3 ), level 4(L4 ), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures-In-Order and Out-Of-Order core block diagram.

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry

FIG. 7 illustrates examples of execution unit(s) circuitry, such as execution unit(s) circuitry 662 of FIG. 6B. As illustrated, execution unit(s) circuity 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

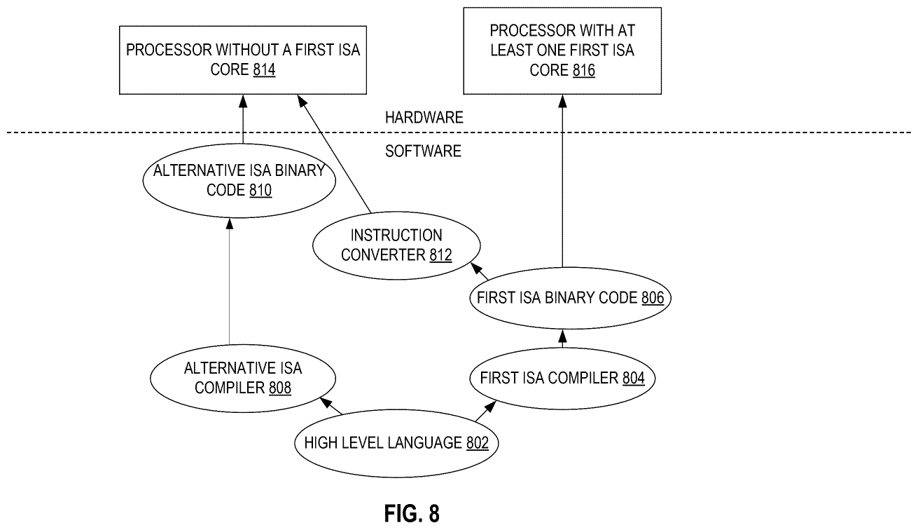

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
instruction decoder circuitry to decode a first instruction, the first instruction including an instruction format, the instruction format having a field for a value to indicate that execution of the first instruction is to include one or more memory tag checking operations;
execution circuitry coupled to the instruction decoder circuitry, the execution circuitry to perform the one or more memory tag checking operations in response to the first instruction, wherein the one or more memory tag checking operations include a memory tag load operation; and
performance monitoring circuitry to count occurrences of an event associated with the memory tag load operation.

2. The apparatus of claim 1, wherein the event is a commitment to retire the first instruction or retirement of the first instruction.

3. The apparatus of claim 1, wherein the event is a dispatch of the memory tag load operation to be executed.

4. The apparatus of claim 1, wherein the event is a decode of the first instruction into a no-operation (NOP).

5. The apparatus of claim 1, wherein the event does not include a data load operation.

6. The apparatus of claim 1, wherein the event is a tagging violation.

7. The apparatus of claim 1, wherein the field is an opcode field.

8. The apparatus of claim 1, wherein the field is a prefix field.

9. A method comprising:
decoding a first instruction, the first instruction including an instruction format, the instruction format having a field for a value to indicate that execution of the first instruction is to include one or more memory tag checking operations;
performing the one or more memory tag checking operations in response to the first instruction, wherein the one or more memory tag checking operations include a memory tag load operation; and
counting occurrences of an event associated with the memory tag load operation.

10. The method of claim 9, wherein the event is a commitment to retire the first instruction or retirement of the first instruction.

11. The method of claim 9, wherein the event is a dispatch of the memory tag load operation to be executed.

12. The method of claim 9, wherein the event is a decode of the first instruction into a no-operation (NOP).

13. The method of claim 9, wherein the event does not include a data load operation.

14. The method of claim 9, wherein the event is a tagging violation.

15. The method of claim 9, wherein the field is an opcode field.

16. The method of claim 9, wherein the field is a prefix field.

17. A non-transitory machine-readable medium having program code stored thereon which, when executed by a machine, causes the machine to perform the operations of:
decoding a first instruction, the first instruction including an instruction format, the instruction format having a field for a value to indicate that execution of the first instruction is to include one or more memory tag checking operations;
performing the one or more memory tag checking operations in response to the first instruction, wherein the one or more memory tag checking operations include a memory tag load operation; and
counting occurrences of an event associated with the memory tag load operation.

18. The non-transitory machine-readable medium of claim 17, wherein the event is a commitment to retire the first instruction or retirement of the first instruction.

19. The non-transitory machine-readable medium of claim 17, wherein the event is a dispatch of the memory tag load operation to be executed.

20. The non-transitory machine-readable medium of claim 17, wherein the event is a decode of the first instruction into a no-operation (NOP).
